(19) United States
(12) Patent Application Publication
(10) Pub. No.: US 2023/0399113 A1
(43) Pub. Date: Dec. 14, 2023

(54) HEATING THERMOPLASTIC MATERIAL USING ELECTRIC HEATER(S) FOR THERMAL ANTI-ICING SYSTEM

(71) Applicant: Rohr, Inc., Chula Vista, CA (US)

(72) Inventor: Jennifer Davis, Carlsbad, CA (US)

(21) Appl. No.: 18/208,564

(22) Filed: Jun. 12, 2023

Related U.S. Application Data
(60) Provisional application No. 63/351,138, filed on Jun. 10, 2022.

(51) Int. Cl. B64D 15/12; H05B 3/28; B32B 27/08

(52) U.S. Cl. CPC B64D 15/12; B32B 27/285; B32B 27/08; H05B 3/286

(57) ABSTRACT

A method is provided during which a preform is provided that includes an electric heater and thermoplastic material. The preform is consolidated to provide an aircraft component. The consolidating includes heating the thermoplastic material using the electric heater. The electric heater is embedded within the thermoplastic material of the aircraft component. The electric heater is configured as a part of a thermal anti-icing system for melting and/or preventing ice accumulation on an exterior surface of the aircraft component.

This application claims priority to U.S. Patent Appln. No. 63/351,138 filed Jun. 10, 2022, which is hereby incorporated herein by reference in its entirety.

### BACKGROUND

### 1. Technical Field

This disclosure relates generally to an aircraft and, more particularly, to forming a composite component for the aircraft.

### 2. Background Information

An aircraft may include various thermoplastic composite components. Various methods are known in the art for forming such composite aircraft components. While these known formation methods have various advantages, there is still room in the art for improvement. There is a need in the art, for example, for methods for forming thermoplastic composite aircraft components using simpler, less expensive consolidation setups.

### SUMMARY OF THE DISCLOSURE

According to an aspect of the present disclosure, a method is provided during which a preform is provided that includes an electric heater and thermoplastic material. The preform is consolidated to provide an aircraft component. The consolidating includes heating the thermoplastic material using the electric heater. The electric heater is embedded within the thermoplastic material of the aircraft component. The electric heater is configured as a part of a thermal anti-icing system for melting and/or preventing ice accumulation on an exterior surface of the aircraft component.

According to another aspect of the present disclosure, another method is provided during which a first member of an aircraft component is provided. The first member is configured from or otherwise includes first thermoplastic material. A second member of the aircraft component is provided. The second member is configured from or otherwise includes second thermoplastic material. The second member is disposed with the first member. At least one of the first member or the second member is heated to bond the first thermoplastic material to the second thermoplastic material using an electric heater. The electric heater is configured as a part of a thermal anti-icing system for melting and/or preventing ice accumulation on an exterior surface of the aircraft component.

According to still another aspect of the present disclosure, another method is provided during which a first member of an aircraft component is provided. The first member is configured from or otherwise includes first thermoplastic material. A second member of the aircraft component is provided. The second member is configured from or otherwise includes second thermoplastic material. Thermoplastic bonding material is disposed between the first member and the second member. The thermoplastic bonding material is different than the first thermoplastic material and the second thermoplastic material. The thermoplastic bonding material is heated to a bonding temperature using an electric heater to bond the first member and the second member together. The bonding temperature is below at least one of a first softening temperature of the first thermoplastic material or a second softening temperature of the second thermoplastic material. The electric heater is configured as a part of a thermal anti-icing system for melting and/or preventing cire accumulation on an exterior surface of the aircraft component.

The electric heater may be configured as part of the first member.

The first member may be heated during the heating using at least the electric heater. The second member may be heated during the heating using at least a second electric heater configured as a part of the second member. The second electric heater may be configured as a second part of the thermal anti-icing system for melting and/or preventing ice accumulation on the exterior surface of the aircraft component.

The first thermoplastic material may be different than the second thermoplastic material.

The method may also include removing material from a damaged aircraft component to provide the first member. The second member may be configured as a patch to replace the removed material. The aircraft component may be a repaired aircraft component.

The preform may also include fiber-reinforcement. The fiber-reinforcement may be embedded within the thermoplastic material of the aircraft component.

The method may also include conforming the preform to tooling by heating the thermoplastic material using the electric heater.

The consolidation may also include applying pressure to the preform.

The providing of the preform may include laying up the electric heater between a first layer and a second layer. The first layer may include a first portion of the thermoplastic material. The second layer may include a second portion of the thermoplastic material.

The electric heater may include a plurality of electric heating elements embedded within the thermoplastic material of the aircraft component.

The electric heating elements may be arranged in a grid and/or an array.

The electric heater may be configured as or otherwise include a carbon nanotube heater embedded within the thermoplastic material of the aircraft component.

The preform may also include a second electric heater. The second electric heater may be embedded within the thermoplastic material of the aircraft component. The second electric heater may be configured as a second part of the thermal anti-icing system for melting and/or preventing ice accumulation on the exterior surface of the aircraft component.

The electric heater may heat up to a first temperature during the heating of the thermoplastic material. The second electric heater may heat up to a second temperature during the heating of the thermoplastic material that is different than the first temperature.

The electric heater and the second electric heater may heat up to a common temperature during the heating of the thermoplastic material.

The method may also include monitoring the consolidation of the preform using a sensor. The sensor may be embedded within the thermoplastic material of the aircraft component.

A nacelle inlet structure may include the aircraft component.

An airfoil may include the aircraft component.

The present disclosure may include any one or more of the individual features disclosed above and/or below alone or in any combination thereof

The foregoing features and the operation of the invention will become more apparent in light of the following description and the accompanying drawings.

### BRIEF DESCRIPTION OF THE DRAWINGS

FIG. 1 is a schematic illustration of an assembly for an aircraft with a composite aircraft component and a thermal anti-icing system.

FIG. 2 is a perspective illustration of the aircraft.

FIGS. 3A-C are partial schematic sectional illustrations of the aircraft component with various different layer configurations.

FIGS. 4A and 4B are partial schematic illustrations of an electric heater with various heating element arrangements.

FIG. 5 is a flow diagram of a method for forming the aircraft component.

FIGS. 6A-C are partial schematic sectional illustrations of a composite preform arranged with tooling.

FIG. 7 is a schematic illustration of the composite preform pressed between the tooling and a vacuum bag during consolidation.

FIG. 8 is a schematic illustration of the aircraft component/the composite preform with multiple electric heaters.

FIG. 9 is a schematic illustration of the aircraft component/the composite preform with one or more internal sensors.

FIGS. 10A-C are schematic illustrations depicting repair of the aircraft component.

FIG. 11 illustrates an alternative joint configuration between members of the aircraft component.

FIG. 12 illustrates the aircraft component/the composite preform between the tooling and the vacuum bag, where the component members are bonded together with thermoplastic bonding material.

FIG. 13 is a partial side sectional illustration of an inlet structure of a nacelle for an aircraft propulsion system.

### DETAILED DESCRIPTION

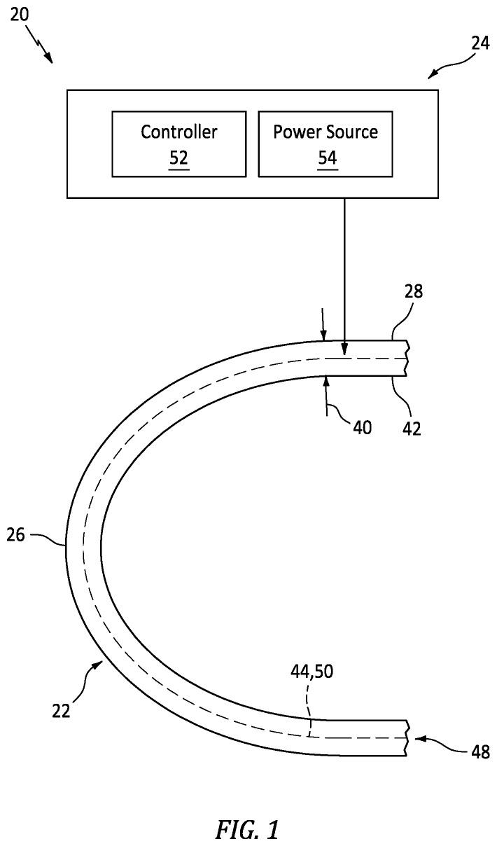

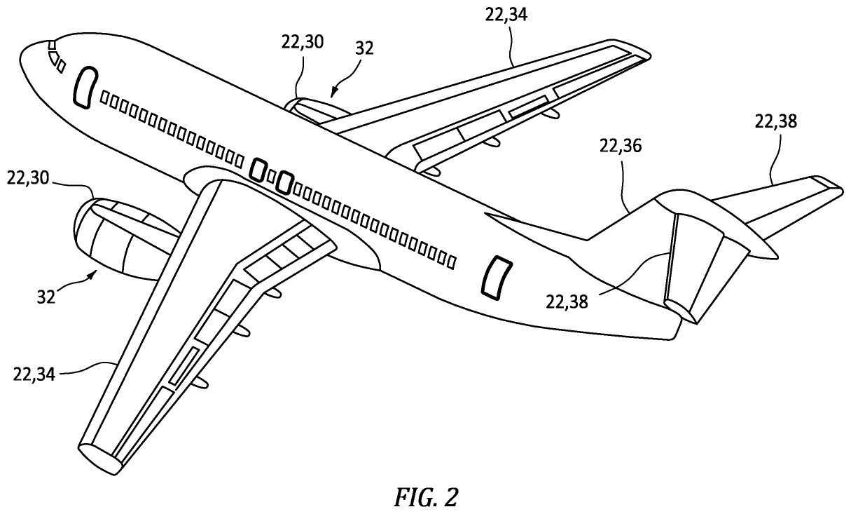

FIG. 1 illustrates an assembly 20 for an aircraft. The aircraft may be configured as an airplane, a helicopter, a drone (e.g., an unmanned aerial vehicle (UAV)), a spacecraft or any other manned or unmanned aerial vehicle. However, for ease of description, the aircraft is described below and illustrated in FIG. 2 as the airplane. The aircraft assembly 20 of FIG. 1 includes a composite aircraft component 22 and a thermal anti-icing system 24.

The aircraft component 22 may be configured as any component of the aircraft with a leading edge 26 and/or at least one aerodynamic exterior surface 28. For example, referring to FIG. 2, the aircraft component 22 may be configured as or included as part of an inlet structure 30 of nacelle for an aircraft propulsion system 32; e.g., an inlet structure noselip. The aircraft component 22 may alternatively be configured as or included as part of an airfoil such as, but not limited to, a wing 34 for the aircraft, a vertical stabilizer 36 for the aircraft, or a horizontal stabilizer 38 for the aircraft. Another example of the airfoil is an inlet guide vane for the aircraft propulsion system 32. The aircraft component 22, however, is not limited to the foregoing exemplary component configurations.

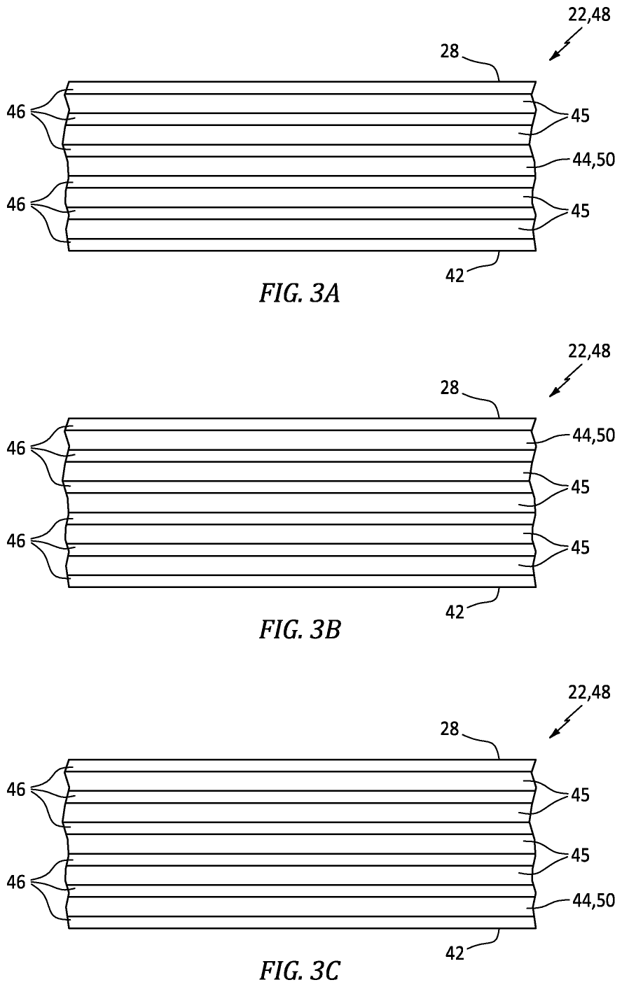

The aircraft component 22 of FIG. 1 extends longitudinally (e.g., axially along an axial centerline and/or lengthwise along an airfoil camber line) to the component leading edge 26. The aircraft component 22 has a thickness 40 that extends laterally between and to an interior surface 42 of the aircraft component 22 and the component exterior surface 28. The aircraft component 22 of FIGS. 3A-C includes at least one electric heater 44, fiber-reinforcement 45 and thermoplastic material 46. The electric heater 44 and the fiber-reinforcement 45 are embedded within the thermoplastic material 46, where the component elements 44-46 collectively form a body 48 (e.g., a skin, a wall, etc.) of the aircraft component 22.

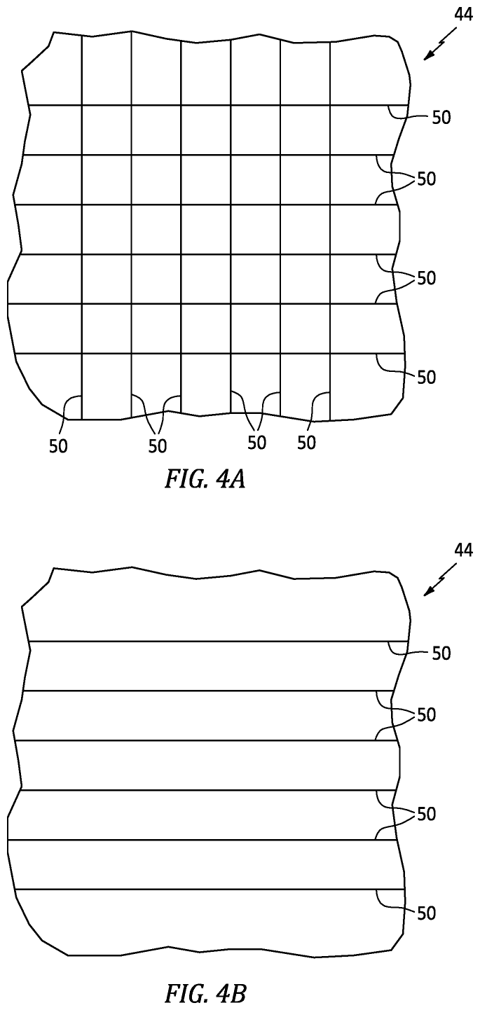

Referring to FIGS. 4A and 4B, the electric heater 44 includes one or more electric heating elements 50 arranged in a grid (e.g., see FIG. 4A), an array (e.g., see FIG. 4B) or any other arrangement. The heating elements 50 may be electrically interconnected to provide a single heating zone across/along the aircraft component 22 and its elements 26 and 28 (see FIG. 1). Alternatively, the heating elements 50 may be configured to provide multiple discrete heating zones across/along the aircraft component 22 and its elements 26 and 28 (see FIG. 1). Each of the heating elements 50 may be configured as an electric carbon nanotube heater. One or more or all of the heating elements 50, however, may alternatively be configured as another type of electrically resistive heating element such as a resistive metal heating wire.

Referring to FIGS. 3A-C, the electric heater 44 and its heating elements 50 are thermally coupled with the component exterior surface 28 through at least the thermoplastic material 46. Referring to FIG. 3A, the electric heater 44 and its heating elements 50 may be arranged (e.g., sandwiched) laterally between multiple layers of the fiber-reinforcement 45 and/or the thermoplastic material 46. The electric heater 44 may thereby be disposed intermediately (e.g., midway) between the component interior surface 42 and the component exterior surface 28. Alternatively, referring to FIG. 3B, the electric heater 44 and its heating elements 50 may be arranged adjacent (or otherwise at) the component exterior surface 28. Still alternatively, referring to FIG. 3C, the electric heater 44 and its heating elements 50 may be arranged adjacent (or otherwise at) the component interior surface 42. The heating elements 50, of course, may also be located at multiple different lateral locations within the component body 48 between the component interior surface 42 and the component exterior surface 28 to provide a multi-layer heater arrangement.

The fiber-reinforcement 45 may be arranged into the one or more reinforcement layers. Each layer of the fiber-reinforcement 45 includes one or more long strand, short strand and/or chopped fibers. Prior to consolidation of the aircraft component 22, the fibers in each reinforcement layer may be woven into a weave or otherwise arranged together to provide a fiber-reinforcement cloth or mat. Examples of the fiber-reinforcement 45 include, but are not limited to, fiberglass material, carbon fiber material and aramid (e.g., Kevlar®) material.

The thermoplastic material 46 provides a thermoplastic matrix into which the electric heater 44 and the fiber-reinforcement 45 are disposed; e.g., embedded, encapsulated, etc. Examples of the thermoplastic material 46 include, but are not limited to, polyether ether ketone (PEEK), and polyetherimide (PEI).

Referring to FIG. 1, the thermal anti-icing system 24 includes the at least one electric heater 44 that is part of and/or embedded within the aircraft component 22. The thermal anti-icing system 24 also include a controller 52 and an electrical power source 54; e.g., one or more batteries, a generator, etc. This thermal anti-icing system 24 is configured to melt and/or prevent ice accumulation on the component exterior surface 28, for example, at (e.g., on, adjacent or proximate) and along the component leading edge 26. The controller 52, for example, may signal the power source 54 (or a switch and/or other regulator between the power source 54 and the electric heater 44) to provide electricity to the electric heater 44. The electricity energizers the electric heater 44 and its heating elements 50, and the electric heater 44 generates heat energy. Referring to FIGS. 3A-C, the heat energy transfers (e.g., conducts) through at least the thermoplastic material 46 towards (e.g., to) the component exterior surface 28 thereby heating the component exterior surface 28 to an elevated temperature.

The elevated temperature may be selected to be warm enough to melt any ice accumulating on the component exterior surface 28 and/or prevent accumulation of the ice on the component exterior surface 28, while cool enough so as not to damage the aircraft component 22 or any surrounding components and/or needlessly expend energy. In particular, the elevated temperature is selected to be less than a melting temperature of the thermoplastic material 46 as well as less than a softening temperature of the thermoplastic material 46. The term “softening” may describe a temperature at which a thermoplastic material becomes soft and permanently deformable; e.g., pliable, malleable, manipulatable, etc. For example, when the thermoplastic material 46 is heated to a temperature above its softening temperature (but below its melting temperature), the thermoplastic material 46 may be soft enough to lose its previous shape due to gravitational sagging and/or other forces. By contrast, when the thermoplastic material 46 is heated to a temperature below its softening temperature, the thermoplastic material 46 may remain stiff and retain its form.

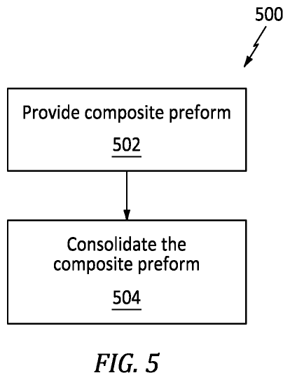

FIG. 5 is a flow diagram of a method 500 for forming a composite aircraft component with at least one internal electric heater. For ease of description, the method 500 is described below with respect to forming the aircraft component 22. The formation method 500 of the present disclosure, however, is not limited to such an exemplary aircraft component.

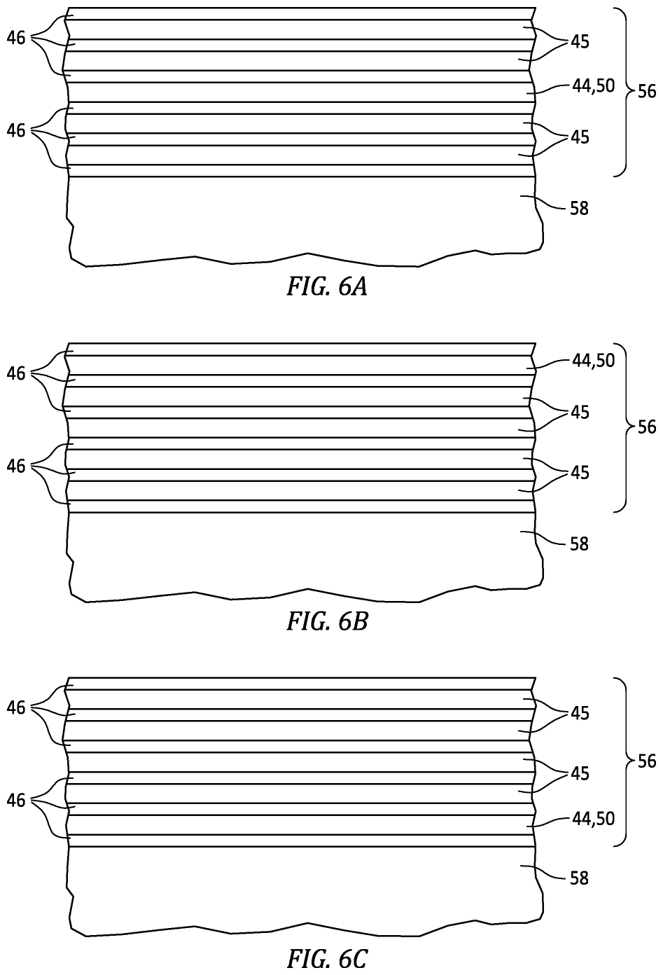

In step 502, a composite preform 56 of the aircraft component 22 is provided. This composite preform 56 may generally have the same shape and dimensions as the aircraft component 22 being formed. Referring to FIGS. 6A-C, the composite preform 56 includes the at least one electric heater 44 and the fiber-reinforcement 45. The composite preform 56 may also include the thermoplastic material 46. The fiber-reinforcement 45 and at least some or all of the thermoplastic material 46, for example, may be provided together as one or more layers (e.g., sheets) of thermoplastic prepreg. The term “thermoplastic prepreg” may describe herein a sheet of fiber-reinforcement that is pre-impregnated with thermoplastic material. To form the composite preform 56, the electric heater 44 may be laid up with the thermoplastic prepreg layers against tooling 58; e.g., a die or other form. The electric heater 44 of FIG. 6A is laid up between the thermoplastic prepreg layers. The electric heater 44 of FIGS. 6B and 6C is laid up to a respective side of the thermoplastic prepreg layers.

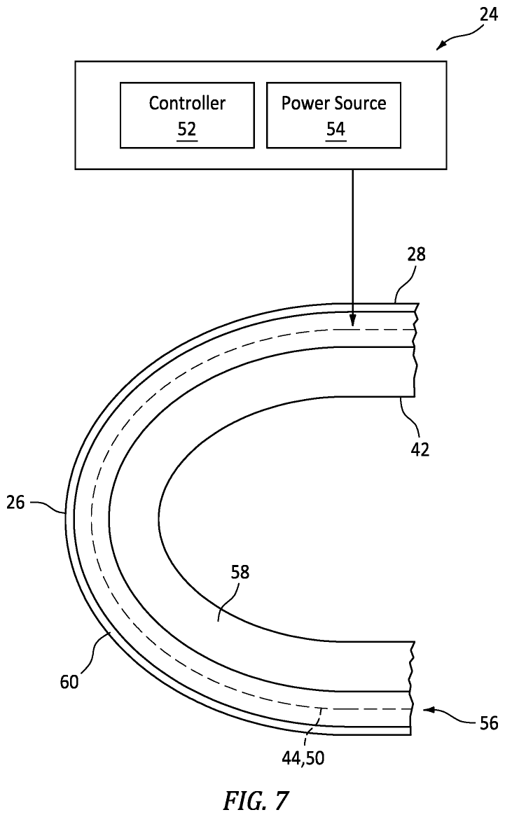

Referring to FIG. 7, the composite preform 56 may be pre-shaped to conform to the tooling 58. Alternatively, the composite preform 56 and its various thermoplastic prepreg layers may be shaped to conform to the tooling 58 by heating the thermoplastic material 46 to a temperature above its softening temperature, but below its melting temperature. This heating may be performed using the electric heater 44 internal to the composite preform 56. The heating, however, may also or alternatively be heated using a heater external to the composite preform 56; although, preferably such an external heating source is not required.

The thermoplastic material 46 of FIGS. 6A-C is included with the fiber-reinforcement 45 in the thermoplastic prepreg layers. Of course, various other techniques are known in the art for delivering thermoplastic material to a preform, and the present disclosure is not limited to any particular ones thereof.

In step 504, the composite preform 56 is consolidated to provide the aircraft component 22. During this consolidation, the composite preform 56 may be subjected to pressure and/or heat to bring together the preform elements 44-46 and then cure the thermoplastic material 46.

Referring to FIG. 7, pressure may be applied to the composite preform 56 using a vacuum bag 60 and the tooling 58. The composite preform 56 of FIG. 7, for example, is disposed between the vacuum bag 60 and the tooling 58 such that the vacuum bag 60 pushes the composite preform 56 against the tooling 58. Alternatively, the composite preform 56 may be pressed between opposing sets of tooling; e.g., an interior die and an exterior die. Of course, various other methods are known in the art for applying pressure to a preform, and the present disclosure is not limited to any particular ones thereof.

To heat the composite preform 56 and, more particularly, the thermoplastic material 46 within the composite preform 56 (see FIGS. 6A-C), at least (or only) the electric heater 44 is energized; e.g., turned on. This electric heater 44 may be energized by the thermal anti-icing system elements 52 and 54, or other similar elements dedicated to component forming, for example. The electric heater 44 and its heating elements 50 thereby produce heat energy and heat up the surrounding material including the thermoplastic material 46 (see FIGS. 6A-C). The heat produced by the electric heater 44 and its heating elements 50 during this consolidation step 504 may be enough (or more than enough) to elevate the thermoplastic material 46 in the thermoplastic prepreg to or above its melting temperature. Of course, in other embodiments, additional heat may also be input from an external heating source (not shown); although, preferably such an external heating source is not required.

It should be noted, the heat energy generated by the electric heater 44 and its heating elements 50 during aircraft operation for thermal anti-icing may be (e.g., significantly) less than that during the consolidation step 504 so as to prevent thermal degradation of one or more other nearby aircraft components as well as prevent excess expenditure of energy as discussed above. For example, during the consolidation, the electric heater 44 may be heated to a relatively high consolidation temperature whereas the electric heater 44 may be heated to a relatively low anti-icing temperature during aircraft operation. The consolidation temperature, of course, may vary depending upon the specific thermoplastic material included in the aircraft component 22.

By using the integral electric heater 44 for the consolidation step 504, no additional heater(s) (e.g., outside of the composite preform 56) are needed for forming the aircraft component 22. This may significantly reduce an initial setup cost for producing the aircraft components 22. Furthermore, the electric heater 44 can heat the thermoplastic material 46 with less interference (e.g., thermal resistance) than a heater external to the composite preform 56 and the tooling 58/the vacuum bag 60.

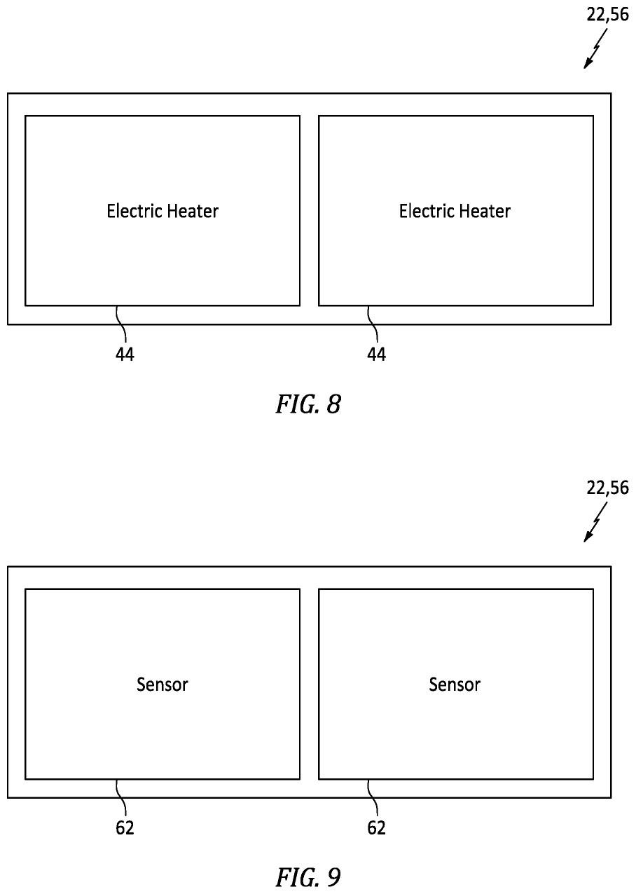

In some embodiments, referring to FIG. 8, the aircraft component 22 may include multiple of the internal electric heaters 44. These electric heaters 44 may be operated to heat the surrounding composite preform material to a common (e.g., the same) temperature during the consolidation step 504. Alternatively, the electric heaters 44 may be operated to heat the surrounding composite preform material to different temperatures during the consolidation step 504. The heating during the consolidation step 504 may thereby be tailored to dimensional differences, etc. in the composite preform 56.

In some embodiments, referring to FIG. 9, the consolidation of the composite preform 56 may be monitored using a sensor system with one or more sensors 62. One or more or all of these sensors 62 may be arranged within the composite preform 56. The sensors 62 may thereby be embedded within the cured thermoset material of the aircraft component 22. These sensors 62 may also or alternatively be used to monitor the thermal anti-icing, the aircraft component 22 and/or an environment surrounding the aircraft component 22 during aircraft operation. Examples of the sensors 62 include, but are not limited to, temperature sensors and pressure sensors.

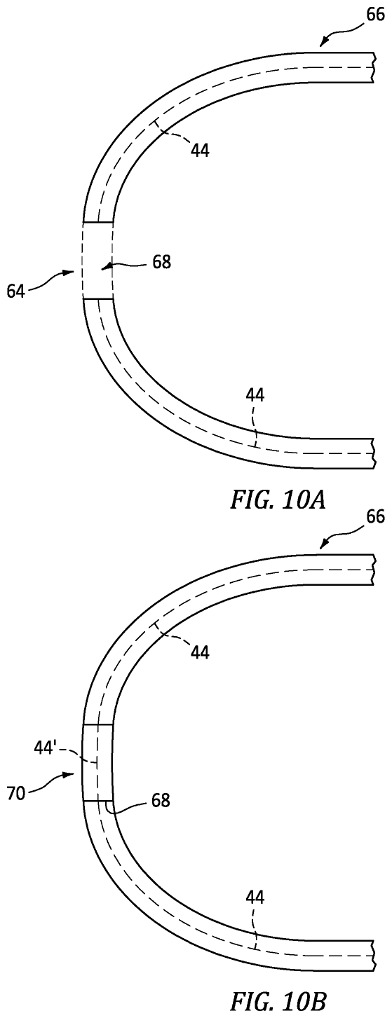

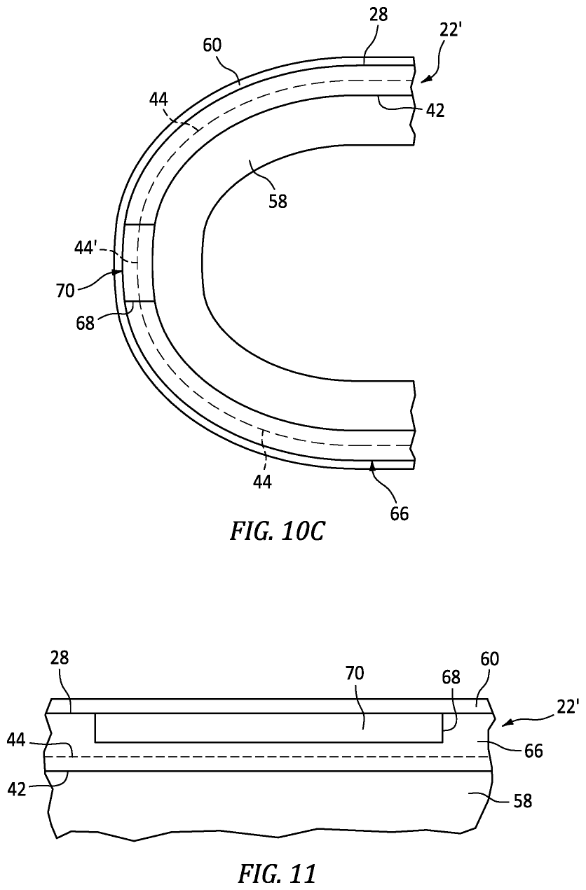

While the electric heater(s) 44 are described above for forming the aircraft component 22, the electric heater(s) 44 may also or alternatively be used for repairing the aircraft component 22. For example, referring to FIG. 10A, a damaged portion 64 of the aircraft component 22 may be removed to provide a base member 66 of a future repaired composite aircraft component 22′ (see FIG. 10C). This base member 66 includes a void 68 (e.g., a hole, a groove, a notch, a recession, a depression, etc.) at a location of where the damaged portion 64 was removed. Referring to FIG. 10B, a repair member 70 is arranged with the base member 66 to fill, cover and/or otherwise patch the void 68. This repair member 70 may have a similar configuration/makeup as the composite preform 56 described above. The repair member 70 of FIG. 10B, for example, includes fiber-reinforcement and thermoplastic material (e.g., similar to that shown in FIGS. 3A-C); e.g., one or more layers of thermoplastic prepreg. The repair member 70 of FIG. 10B also include at least one electric heater 44′ laid up with the thermoplastic prepreg layers (e.g., similar to that shown in FIGS. 3A-C). Referring to FIG. 10C, the repair member 70 may be pressed against the base member 66 using the tooling 58, the vacuum bag 60 and/or other techniques. The thermoplastic material in the repair member 70 and/or the thermoplastic material in the base member 66 may then be heated by the electric heater 44′ in the repair member 70 and/or the electric heater(s) 44 in the base member 66 to bond the repair member 70 to the base member 66. The repair member 70 may thereby be consolidated with the base member 66 to form the repaired aircraft component 22′.

In some embodiments, the electric heater 44′ in the repair member 70 of the repaired aircraft component 22′ may be included as a part of the thermal anti-icing system 24 (see FIG. 1). Of course, in other embodiments, the repair member 70 may be configured without its own integral electric heater.

In some embodiments, the repair member 70 may be formed to fit into the void 68 as shown, for example, in FIGS. 10B and C. However, in other embodiments, the repair member 70 may alternatively overlap the base member 66 as shown, for example, in FIG. 11.

The member 66 is described above as a part of a damaged aircraft component and the member 70 is described as a repair member for patching the void 68 in the damaged aircraft component. However, it is contemplated that multiple new (e.g., non-damaged) members may be joined together using the foregoing consolidation and bonding process to form a new (e.g., non-repaired) aircraft component.

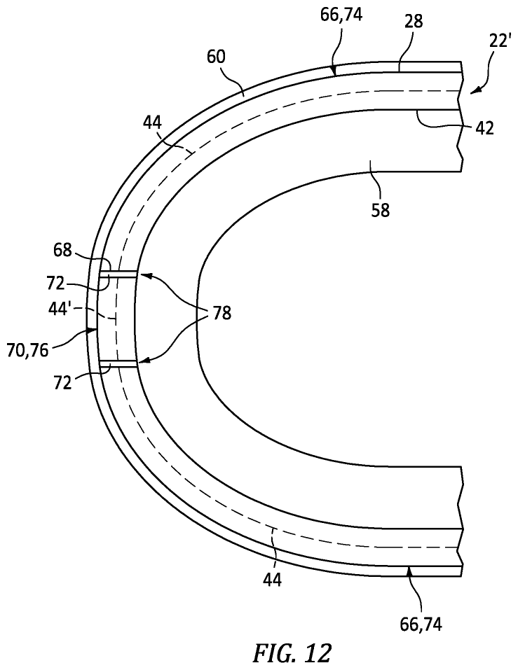

In some embodiments, referring to FIG. 12, at least one layer of thermoplastic bonding material 72 is disposed between first and second members 74 and 76 of the aircraft component 22; e.g., the component members 66 and 70. This thermoplastic bonding material 72 is heated using any one or more of the electric heaters 44, 44′ to or above the consolidation temperature to bond the thermoplastic bonding material 72 to the first and the second members 74 and 76. The thermoplastic bonding material 72 may thereby bond the first and the second members 74 and 76 together at an intermember joint 78. Of course, additional heat may also be input for the bonding from an external heating source (not shown); although, preferably such an external heating source is not required.

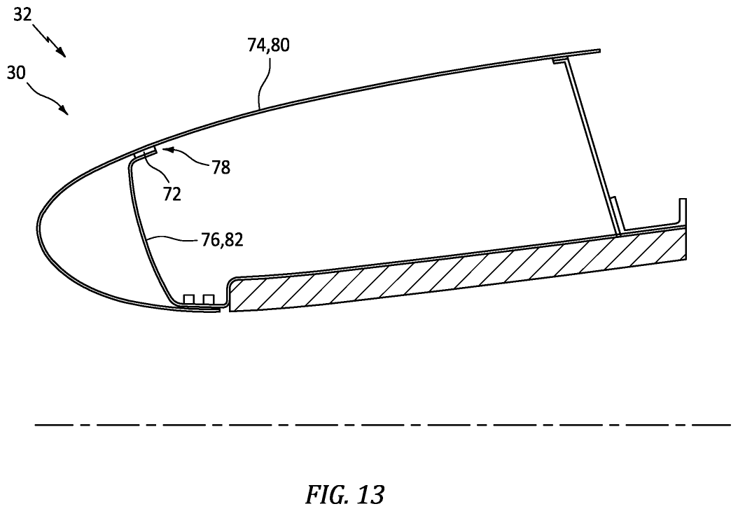

The thermoplastic bonding material 72 may be different than the thermoplastic material in the first member 74 and/or the thermoplastic material in the second member 76. The thermoplastic bonding material 72, for example, may be selected to bond to the first and the second members 74 and 76 at a temperature that is below the melting point of the first and the second thermoplastic materials and, for example, below the softening point of the first and the second thermoplastic materials. For example, the thermoplastic bonding material 72 may be polyetherimide (PEI), and the first and the second thermoplastic materials may be polyether ether ketone (PEEK). With such an arrangement, the first and the second members 74 and 76 may retain their shape, dimensions, etc. while being bonded together by the thermoplastic bonding material 72. Furthermore, the first and the second members 74 and 76 may be readily de-bonded similarly using the internal electric heater(s) 44, 44′. This may facilitate manufacture and/or repair of, for example, the nacelle inlet structure 30 of FIG. 13, where an exterior skin 80 may be the first member 74, a bulkhead 82 may be the second member 76. With such an arrangement, the exterior skin 80 may be removably attached to the bulkhead 82, for example, without any mechanical fasteners. Of course, various other aircraft components may also utilize such a construction.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A method, comprising:
providing a preform that includes an electric heater and thermoplastic material; and
consolidating the preform to provide an aircraft component, the consolidating comprising heating the thermoplastic material using the electric heater, the electric heater embedded within the thermoplastic material of the aircraft component, and the electric heater configured as a part of a thermal anti-icing system for melting and/or preventing ice accumulation on an exterior surface of the aircraft component.

2. The method of claim 1, wherein
the preform further includes fiber-reinforcement; and
the fiber-reinforcement is embedded within the thermoplastic material of the aircraft component.

3. The method of claim 1, further comprising conforming the preform to tooling by heating the thermoplastic material using the electric heater.

4. The method of claim 1, wherein the consolidation further comprises applying pressure to the preform.

5. The method of claim 1, wherein
the providing of the preform comprises laying up the electric heater between a first layer and a second layer;
the first layer includes a first portion of the thermoplastic material; and
the second layer includes a second portion of the thermoplastic material.

6. The method of claim 1, wherein the electric heater comprises a plurality of electric heating elements embedded within the thermoplastic material of the aircraft component.

7. The method of claim 6, wherein the electric heating elements are arranged in a grid and/or an array.

8. The method of claim 1, wherein the electric heater comprises a carbon nanotube heater embedded within the thermoplastic material of the aircraft component.

9. The method of claim 1, wherein
the preform further includes a second electric heater;
the second electric heater is embedded within the thermoplastic material of the aircraft component; and
the second electric heater is configured as a second part of the thermal anti-icing system for melting and/or preventing ice accumulation on the exterior surface of the aircraft component.

10. The method of claim 9, wherein
the electric heater heats up to a first temperature during the heating of the thermoplastic material; and
the second electric heater heats up to a second temperature during the heating of the thermoplastic material that is different than the first temperature.

11. The method of claim 9, wherein the electric heater and the second electric heater heat up to a common temperature during the heating of the thermoplastic material.

12. The method of claim 1, further comprising:
monitoring the consolidation of the preform using a sensor;
the sensor embedded within the thermoplastic material of the aircraft component.

13. The method of claim 1, wherein a nacelle inlet structure comprises the aircraft component.

14. The method of claim 1, wherein an airfoil comprises the aircraft component.

15. A method, comprising:
providing a first member of an aircraft component, the first member comprising first thermoplastic material;
providing a second member of the aircraft component, the second member comprising second thermoplastic material;
disposing the second member with the first member; and
heating at least one of the first member or the second member to bond the first thermoplastic material to the second thermoplastic material using an electric heater, the electric heater configured as a part of a thermal anti-icing system for melting and/or preventing ice accumulation on an exterior surface of the aircraft component.

16. The method of claim 15, wherein the electric heater is configured as part of the first member.

17. The method of claim 16, wherein
the first member is heated during the heating using at least the electric heater;
the second member is heated during the heating using at least a second electric heater configured as a part of the second member; and
the second electric heater is configured as a second part of the thermal anti-icing system for melting and/or preventing ice accumulation on the exterior surface of the aircraft component.

18. The method of claim 15, wherein the first thermoplastic material is different than the second thermoplastic material.

19. The method of claim 15, further comprising removing material from a damaged aircraft component to provide the first member, wherein the second member is configured as a patch to replace the removed material, and the aircraft component is a repaired aircraft component.

20. A method, comprising:
providing a first member of an aircraft component, the first member comprising first thermoplastic material;
providing a second member of the aircraft component, the second member comprising second thermoplastic material;
disposing thermoplastic bonding material between the first member and the second member, the thermoplastic bonding material different than the first thermoplastic material and the second thermoplastic material; and
heating the thermoplastic bonding material to a bonding temperature using an electric heater to bond the first member and the second member together, the bonding temperature below at least one of a first softening temperature of the first thermoplastic material or a second softening temperature of the second thermoplastic material, and the electric heater configured as a part of a thermal anti-icing system for melting and/or preventing cire accumulation on an exterior surface of the aircraft component.
